(19) United States
(12) Patent Application Publication
(10) Pub. No.: US 2012/0141598 A1
(43) Pub. Date: Jun. 7, 2012

(54) BROAD SPECTRUM DECONTAMINATE AND DISPERSEMENT SYSTEM

(76) Inventor: Jessie Kater, San Diego, CA (US)

(21) Appl. No.: 12/471,231

(22) Filed: May 22, 2009

Related U.S. Application Data
(60) Provisional application No. 61/103,878, filed on Oct. 8, 2008.
(60) Provisional application No. 61/104,213, filed on Oct. 9, 2008.

(51) Int. Cl. A01N 59/00; A01N 37/02; A01P 1/00; A01N 37/18

(52) U.S. Cl. 424/616; 514/616; 424/722; 514/557

(57) ABSTRACT

The invention relates to a composition for decontaminating a toxin present in a polar or non-polar matrix. The composition includes (a) at least one activator that generates reactive oxygen species when reacted with an oxygen radical donator, and (b) at least one oxygen radical donator to react with the activator to create reactive oxygen species. The composition may also include one or more oxidizing agents that include reactive oxygen species.

### PRIORITY CLAIM

This application claims priority from U.S. Provisional Application, No. 61/103,878, filed Oct. 8, 2008 and entitled “Broad Spectrum Decontaminate and Dispersement System,” and from U.S. Provisional Application No. 61/104,213 filed Oct. 9, 2008 and entitled “Broad Spectrum Decontaminate and Dispersement System.”

### FIELD OF THE INVENTION

The present invention relates to a substance for decontaminating toxins present in the air or on a surface.

### BACKGROUND AND SUMMARY OF THE INVENTION

It is known that reactive species of oxygen (hereafter, “oxygen radicals” or “ROₓ”) render chemical and/or biological agents (collectively, “toxins” and singularly, “toxin”) inactive, which is referred to herein as “decontamination.” A substance that decontaminates toxins is referred to herein as a “decontaminant.”

The present invention is a decontaminant designed to decontaminate one or more of a chemical agent (such as a chemical warfare agent) and a biological agent (such as a biopathogen). The decontaminant utilizes a chemical activation agent, rather than energy from a plasma arc, ultraviolet light or other such energy source, to generate excess oxygen radicals. It is designed to work in an open environment (such as outdoors, rather than in an environmentally-controlled space) and at temperatures ranging from about −25° F. to 125° F. A decontaminant according to the invention can be used in many applications, including on irregular surfaces and/or to destroy toxins in the air.

In one preferred embodiment, the decontaminant includes: (i) a mixture of organic and aqueous liquids that solubilize toxins, and (ii) one or more activators that generate additional reactive oxygen species when reacted with an oxidizing agent, which hydrolyze (and thus decontaminate) toxins, and one or more oxidizing agents. This decontaminant may be deployed utilizing any suitable method or device for one or both of surface decontamination and aerosol decontamination.

A decontaminant according to the invention can be formulated to meet the Joint Program Executive Office for Chemical and Biological Defense (“JPEO”) requirements and be effective against chemical agents including nerve and blister agents (V class, G class and H class) as well as bacteria, viruses and other toxins.

Additionally, it can be formulated to be effective over a temperature range of −25° F. to 125° F.

Constituents that may be used in the practice of the invention are described below:

### Solvent

A decontaminant according to the invention may include an organic solvent to solubilize chemical agents (which typically have a non-polar matrix) and/or an aqueous solvent (preferably water) to solubilize biological agents (which typically are soluble in a polar, such as an aqueous, matrix). The toxins are solubilized by the solvent in order to increase the efficiency of the decontamination. The organic solvent is preferably one or more of ethanol, 2,3 butane diol, and 1-hexanol, although any suitable organic solvent(s) may be used.

### Oxygen Radical Donators

A decontaminant according to the invention preferably includes one or more oxygen radical donators. An oxygen radical donator (ROₓ) that may be used with the invention can be hydrogen peroxide as a component of the starting mixture or hydrogen peroxide or other oxygen moieties generated via a chemical reaction, as understood by those skilled in the art. Other suitable oxygen radical donators may be used.

### Activators Providing Additional Oxygen Radicals

One or more activators are included in a decontaminant according to the invention. The activators(s) generate additional reactive oxygen species when reacted with the one ore more oxygen radical donators (such as hydrogen peroxide). In a preferred embodiment, hydrogen peroxide and the activator react to create peroxyacetic acid (PAA), which is an oxidizing agent. A preferred activator is tetra acetyl ethylene diamine (TAED), although any suitable activator(s) may be used. The activator(s) (sometimes referred to herein as a “dry activator”) is preferably dry and in a powder form.

### Buffer

One or more buffers may be used to increase the pH of the composition forming the decontaminant and the buffer is preferably NaOH provided in dry, powder form or in a 5.5Molar (M) solution. The pH is preferably raised to at least about 6.8, most preferably to about 7.1-7.2, and preferably no higher than about 7.5, in order to better facilitate the reaction between the oxygen radical donator(s) and the activator(s). If used, the buffer may be any suitable material(s) for raising the pH to a desired level.

### Oxidizing Agents

One or more oxidizing agents (sometimes referred to herein as a “liquid activator”) are included in a decontaminant according to the invention. The oxidizing agent includes reactive oxygen species and is used to decontaminate the contaminant. An oxidizing agent according to the invention may include PAA, although any suitable oxidizing agent(s) may be used.

### System

The various constituents described above are shipped and stored in separate containers and mixed to form a decontaminant prior to use. In one embodiment, the constituents are shipped and stored in four containers, with one container including the solvent (preferably water and an organic solvent) and the oxygen radical donator (preferably hydrogen peroxide), one including the oxidizing agent (preferably PAA), one including a liquid activator (preferably 5.5 M NaOH) and one including the dry activator (preferably TAED).

A decontaminant according to the invention may be dispersed into the air or onto a surface and any suitable method or device may be utilized for this purpose. Any nozzle that generates relatively uniform particles that can remain suspended in the air may be used.

A preferred decontaminant according to the invention is set forth on the following page:

TABLE I
Components for a Preferred Embodiment of a Decontaminant
PART 1 - Liquid

| Compound | mL | | % by Volume |
|---|---|---|---|
| Ethanol or 2,3 butane diol | 500 | mL | 52.66 |
| 1-Hexanol | 50 | mL | 5.19 |
| Hydrogen Peroxide and/or organic | 77.5 | mL | 7.99 |
| peroxides | | | |
| Water | 321.5 | mL | 34.16 |
| Totals | 949 | mL | 100% |

PART 2 - Dry Activator

| Compound | g | | % by Volume |
|---|---|---|---|
| TAED | 45.0 | g | — |
| NaOH (dry powder) | 20.0 | g** | — |

PART 3 - Liquid Activator

| Compound | mL | | % by Volume |
|---|---|---|---|
| Peroxyacetic Acid | 19.97 | mL | 39.00% |
| Acetic Acid | 31.23 | mL | 61.00% |
| Totals | 51.2 | mL | 100% |

After this 3-part chemistry system shown in Table I is mixed and ready to use, the decontaminant formula would be similar to that described below in Table II.

TABLE II
Approximate Composition of the
Decontaminant after mixing the constituents listed in Table I.

| Deployable BIT ™-500 Final Mix | % of Final Volume when mixed |
|---|---|
| Ethanol or 2.3 butaine doil | 43.92 |
| Water | 34.91 |
| 1-Hexanol | 4.29 |
| Hyrdorgen Peroxide | 6.87 |
| Peroxyacetic acid | 1.71 |
| Acetic Acid | 2.68 |
| DAED (by-product) | 3.9 |
| NaOH* (dissolved) | 1.72 |

*NaOH powder is preferably mixed in water to a total amount of 100 mL before placement into the decontaminant. The alternative is to transport 100 mL of 5.5 Molar NaOH.

What is claimed is:

1. A decontaminant comprising (a) one or more oxygen radical donators that include oxygen radicals, (b) one or more activators that generate reactive oxygen species when reacted with the one or more oxygen radical donators, and (c) one or more oxidizing agents.

2. The decontaminant of claim 1 wherein the one or more oxygen radical donators comprises one or more of the group consisting of hydrogen peroxide and other organic peroxides.

3. The decontaminant of claim 1 wherein the one or more radical donators comprises hydrogen peroxide.

4. The decontaminant of claim 1 wherein each of the one or more activators is dry prior to mixing it to form the decontaminant.

5. The decontaminant of claim 1 that further includes a liquid solvent for solubilizing toxins that are in a non-polar matrix.

6. The decontaminant of claim 5 wherein the liquid solvent comprises one or more of the group selected from ethanol, 2,3 butane diol and 1-hexanol.

7. The decontaminant of claim 5 wherein the liquid solvent comprises ethanol and 2,3 butane diol.

8. The decontaminant of claim 1 that further includes water.

9. The decontaminant of claim 5 that further includes water.

10. The decontaminant of claim 1 wherein the activator comprises TAED.

11. The decontaminant of claim 1 wherein the activator comprises dry a 5.5 M solution of NaOH.

12. The decontaminant of claim 4 wherein the activator comprises TAED.

13. The decontaminant of claim 1 wherein the one or more oxidizing agents comprises one or more of the group consisting of peroxyacetic acid, acetic acid and other organic peroxides.

14. The decontaminant of claim 1 wherein the oxidizing agent comprises peroxyacetic acid.

15. The decontaminant of claim 1 that includes a buffer for raising the pH.

16. The decontaminant of claim 15 wherein the buffer raises the pH to about 7.1-7.2.

17. The decontaminant of claim 15 wherein the buffer is NaOH.

18. A decontaminate comprising (a) one or more of ethanol, 2,3 butane diol and 1-hexanol, (b) water, (c) hydrogen peroxide, (d) acetic acid, and (e) TAED.

19. A decontaminate in accordance with claim 18 that includes between 40-44% of ethanol and/or 2,3 butane diol by volume.

20. A decontaminate in accordance with claim 18 that includes between 32-36% water by volume.

21. A decontaminate in accordance with claim 18 that includes between 3.5-5% 1-hexanol by volume.

22. A decontaminate in accordance with claim 18 that includes between 5.5-8% hydrogen peroxide by volume.

23. A decontaminate in accordance with claim 18 that includes between 1-4% peroxyacetic acid by volume.

24. A decontaminate in accordance with claim 18 that includes between 2-3% acetic acid by volume.

25. A decontaminate in accordance with claim 18 that includes between 3-6% TAED by volume.

26. A decontaminate in accordance with claim 18 that includes between 1-2.5% NaOH by volume.

27. A decontaminant that includes:
a. a mixture of organic and aqueous liquids that solubilize at least some toxins;
b. one or more activators that generate reactive oxygen species when reacted with an oxygen radical donator; and
c. one or more oxygen radical donators to react with the one or more activators to create reactive oxygen species.

28. The decontaminant of claim 27 that further includes one or more oxidizing agents.

29. The decontaminant of claim 27 that further includes a buffer for raising the pH.

30. The decontaminate of claim 29 wherein the buffer raises the pH to about 7.1-7.2.

31. The decontaminant of claim 29 wherein the buffer is NaOH.

32. The decontaminant of claim 27 wherein each of the one or more activators is dry prior to mixing to form the decontaminant.

33. The decontaminant of claim 27 wherein the liquids include water and one or more of the group selected from ethanol, 2,3 butane diol and 1-hexanol.

34. The decontaminant of claim 27 wherein the activator includes TAED.

35. The decontaminant of claim 28 wherein the one or more oxidizing agents includes one or more of the group consisting of peroxyacetic acid and acetic acid.

36. The decontaminant of claim 27 wherein the one ore more liquid oxygen radical donators comprises hydrogen peroxide.

37. The decontaminant of claim 27 wherein the one or more liquid oxygen radical donators comprises one or more of the group consisting of hydrogen peroxide and other organic peroxides.
